(19) United States
(12) Patent Application Publication
(10) Pub. No.: US 2007/0233443 A1
(43) Pub. Date: Oct. 4, 2007

(54) Computer-aided ultrahigh-frequency circuit model simulation method and system

(75) Inventors: Chun-Yu Lai, Taipei (TW); Feng-Ming Hsu, Taipei (TW)

Correspondence Address: FULBRIGHT AND JAWORSKI LLP, 555 S. FLOWER STREET, 41ST FLOOR, LOS ANGELES, CA, 90071, US

(73) Assignee: INVENTEC CORPORATION

(21) Appl. No.: 11/394,974

(22) Filed: Mar. 30, 2006

(51) Int. Cl. G06F 17/50

(52) U.S. Cl. 703/14

(57) ABSTRACT

A computer-aided ultrahigh-frequency circuit model simulation method and system is proposed, which is designed for use in conjunction with a computer platform for providing a user-operated ultrahigh-frequency circuit model simulation function, which is characterized by the provision of a graphic interface that allows the user to select a desired circuit model and input a set of design parameters about the selected circuit model, and whereupon a set of operating characteristics data can be automatically determined through simulation. This feature allows the circuit design engineer unnecessary to write lengthy circuit model description files for the description of the intended circuit models, thereby making the simulation of high-speed digital circuit models more convenient and efficient.

### BACKGROUND OF THE INVENTION

1. Field of the Invention

This invention relates to computer aided circuit simulation technology, and more particularly, to a computer-aided ultrahigh-frequency circuit model simulation method and system which is designed for use in conjunction with a computer platform, such as a CAD (Computer-Aided Design) workstation, for providing the CAD workstation with an ultrahigh-frequency circuit model simulation function that allows the user to simulate an ultrahigh-frequency circuit model, such as a high-speed digital circuit model used for mobile communications, with the purpose of determining the operating characteristics of the ultrahigh-frequency circuit model during actual operation.

2. Description of Related Art

With the advent of wireless digital communication technologies, such as wireless networking, mobile phones, GPS (Global Positioning System), etc., the design and manufacture of high-speed digital circuit boards that handle digital signals within the gigahertz range is in high demand in the electronics industry. In circuit layout design, high-speed digital circuit boards typically use microstrips for transmission of digital signals within the range of ultra-high frequencies (UHF), typically from 1 GHz to 3 GHz (gigahertz).

HSPICE is a CAD (Computer-Aided Design) software program that is widely utilized for the design and simulation of high-speed digital circuits to obtain theoretical operating characteristics of the high-speed digital circuits under actual operating conditions. One drawback to the present versions of HSPICE programs, however, is that it requires the user to write a lengthy circuit model description file that should include all the related design parameters of the intended circuit model, such as transmission line sizes, physical characteristics, line gaps, dielectric constant of the circuit board being used, to name just a few. Moreover, in the design of some special types of high-speed digital circuits, the circuit model description file should further include an RLGC (Resistance-Inductance-Conductance-Capacitance) model for a stacked structure of the circuit board, where the RLGC model requires the circuit design engineer to write a dedicated computer program for description of the characteristics of the stacked structure as well as the geometry, dimensional parameters, and coordinates of the microstrips being used in the circuit layout. Finally, a field solver is used to determine the architecture of the RLGC model. This practice, however, is quite tedious, laborious, time-consuming, and error-prone for the circuit design engineer to implement. In addition, this method is incapable of determining crosstalk coefficients for a circuit model of transmission line pair, thus undesirably resulting in a space-consuming circuit layout for a complex network of transmission lines on the circuit board.

### SUMMARY OF THE INVENTION

It is therefore an objective of this invention to provide a computer-aided ultrahigh-frequency circuit model simulation method and system which allows the circuit design engineers to implement a simulation task more conveniently and efficiently for various circuit models of high-speed digital circuits.

The computer-aided ultrahigh-frequency circuit model simulation method and system according to the invention is designed for use in conjunction with a computer platform, such as a CAD workstation, for providing an ultrahigh-frequency circuit model simulation function that allows the user to simulate an ultrahigh-frequency circuit model, such as a high-speed digital circuit model used for mobile communications, with the purpose of determining the operating characteristics of the ultrahigh-frequency circuit model during actual operation.

In conception, the computer-aided ultrahigh-frequency circuit model simulation method according to the invention comprises: (1) displaying a graphic interface on the computer platform for providing a user-operated circuit model selection function and a user-operated design parameter input function, wherein the user-operated circuit model selection function provides a group of predefined circuit models for user-selection, and the user-operated design parameter input function is used for input of a set of design parameters in relation to a user-selected circuit model; (2) processing the user-inputted design parameters based on a set of simulation equations related to the user-selected circuit model for obtaining a set of operating characteristics data about the user-selected circuit model; and (3) outputting the operating characteristics data on the computer platform.

In architecture, the computer-aided ultrahigh-frequency circuit model simulation system according to the invention comprises: (A) a graphic-interface circuit model defining module, which is capable of displaying a graphic interface on the computer platform for providing a user-operated circuit model selection function and a user-operated design parameter input function, wherein the user-operated circuit model selection function provides a group of predefined circuit models for user-selection, and the user-operated design parameter input function is used for input of a set of design parameters in relation to a user-selected circuit model; (B) a design parameter processing module, which is capable of processing the user-inputted design parameters received by the graphic-interface circuit model defining module based on a set of simulation equations related to the user-selected circuit model for obtaining a set of operating characteristics data about the user-selected circuit model; and (C) a simulation result output module, which is capable of outputting the operating characteristics data obtained by the design parameter processing module on the computer platform.

The computer-aided ultrahigh-frequency circuit model simulation method and system according to the invention is characterized by the provision of a graphic interface that allows the user to select a desired circuit model and input a set of design parameters about the selected circuit model, and whereupon a set of operating characteristics data can be automatically determined through simulation. This feature allows the circuit design engineer unnecessary to write lengthy circuit model description files for the description of the intended circuit models, thereby making the simulation of high-speed digital circuit models more convenient and efficient.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application and object-oriented component model of the computer-aided ultrahigh-frequency circuit model simulation system according to the invention; and

FIG. 2 shows an example of a user graphic interface displayed on a computer platform by the computer-aided ultrahigh-frequency circuit model simulation system of the invention.

### DETAILED DESCRIPTION OF PREFERRED EMBODIMENTS

The computer-aided ultrahigh-frequency circuit model simulation method and system according to the invention is disclosed in full details by way of preferred embodiments in the following with reference to the accompanying drawings.

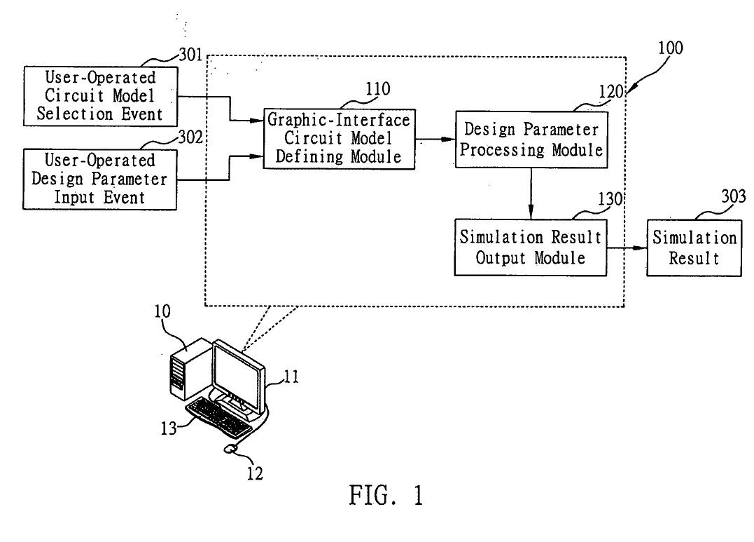

FIG. 1 is a schematic diagram showing the application and object-oriented component model of the computer-aided ultrahigh-frequency circuit model simulation system according to the invention (which is here encapsulated in a dotted block indicated by the reference numeral 100). As shown, the computer-aided ultrahigh-frequency circuit model simulation system of the invention 100 is designed for use in conjunction with a computer platform 10, such as a computer-aided circuit design workstation, for providing the computer platform 10 with a user-operated ultrahigh-frequency circuit model simulation function that allows the user (i.e., a high-speed digital circuit design engineer) to simulate an ultrahigh-frequency circuit model, such as a high-speed digital circuit model used for mobile communications, with the purpose of determining the operating characteristics of the ultrahigh-frequency circuit model during actual operation.

As shown in FIG. 1, in architecture, the computer-aided ultrahigh-frequency circuit model simulation system of the invention 100 is based on an object-oriented component model which comprises: (A) a graphic-interface circuit model defining module 110; (B) a design parameter processing module 120; and (C) a simulation result output module 130. In practical implementation, the computer-aided ultrahigh-frequency circuit model simulation system of the invention 100 can be fully realized by software and integrated as a plug-in module to an existing circuit simulation program, such as HSPICE.

Firstly, the respective attributes and behaviors of these constituent components 110, 120, 130 of the computer-aided ultrahigh-frequency circuit model simulation system of the invention 100 are described in details in the following.

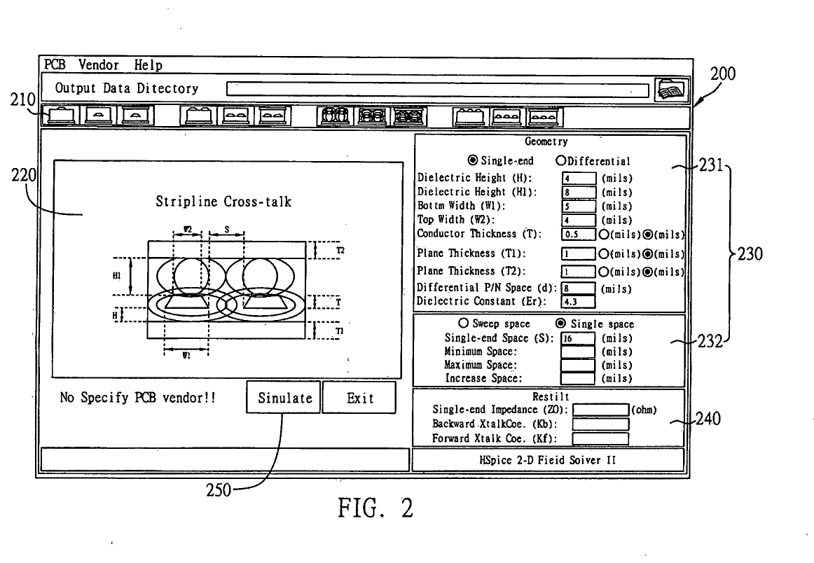

The graphic-interface circuit model defining module 110 is capable of displaying a graphic interface 200 as illustrated in FIG. 2 on the monitor screen 11 of the computer platform 10 for the user to select a circuit model and input related design parameters about the selected circuit model. In the embodiment of FIG. 2, for example, the graphic interface 200 includes a circuit model selection bar 210, a circuit model display area 220, a design parameters input area 230, and a simulation result display area 240. The circuit model selection bar 210 displays a group of circuit model icons that can be user-selected by using the mouse 12 to click on an icon the represents the desired circuit model. The circuit model display area 220 is used to display a schematic graphic representation of the user-selected circuit model. The design parameters input area 230 includes a number of input boxes for the user to utilize the keyboard 13 to input the numerical values of a set of design parameters in relation to the user-intended design of the user-selected circuit model (note that for different circuit models, the design parameters input area 230 will display different input boxes for the input of different design parameters). The simulation result display area 240 is used to display the simulation result, which is a set of data showing the simulated operating characteristics of the user-selected circuit model. In the example of FIG. 2, it is assumed that the user-selected circuit model is a pair of ultrahigh-frequency transmission lines. In this case, the design parameters input area 230 displays two data input areas, a dimensional parameter input area 231 and a gap width input area 232; wherein the dimensional parameter input area 231 is used to input a set of dimension-related parameters about the geometrical structure of the transmission line pair, which include height H of the first dielectric layer, height H1 of the second dielectric layer, width W of the bottom side, width W of the top side, line thickness T, thickness T1 of the first plane, thickness 72 of the second plane, and so on; while the gap width input area 232 is used to input a set of design parameters related to the line gap of the transmission line pair (which is related to the crosstalk effect in the operating characteristics of the transmission line pair). After the user has inputted a set of design parameters via the design parameters input area 230, the user can then click on the [Simulate] button 250, whereby the graphic-interface circuit model defining module 110 is activated to issue a design parameter processing enable message to the design parameter processing module 120. In summary, the graphic-interface circuit model defining module 110 is designed to respond to two user-operation events: a user-operated circuit model selection event 301 and a user-operated design parameter input event 302, wherein the user-operated circuit model selection event 301 is initiated when the user selects a circuit model from the circuit model selection bar 210 by using the mouse 12; while the user-operated design parameter input event 302 is initiated when the user has inputted a set of design parameters to the design parameters input area 230 by using the keyboard 13.

The design parameter processing module 120 is capable of processing the user-inputted design parameters received by the graphic-interface circuit model defining module 110 based on a set of simulation equations related to the user-selected circuit model for obtaining a set of simulated operating characteristics about the user-selected circuit model. In the example of FIG. 2, if the user-selected circuit model is a transmission line pair, then the operating characteristics of this circuit model include characteristic impedance, backward crosstalk coefficient, and forward crosstalk coefficient. The values of these operating characteristics can be determined by the design parameter processing module 120 based on the user-inputted design parameters. Since the equations for determining the values of these operating characteristics are well-known in electronics, detailed description thereof will not be given in this specification.

The simulation result output module 130 is capable of outputting a set of operating characteristics data 303 obtained by the design parameter processing module 120 through the simulation result display area 240 of the graphic interface 200 displayed on the monitor screen 11 of the computer platform 10. In the example of FIG. 2, if the user-selected circuit model is a transmission line pair, the simulation result output module 130 will display its characteristic impedance Z₀, backward crosstalk coefficient Kb, and forward crosstalk coefficient Kf through the simulation result display area 240. Beside the embodiment of FIG. 2, the operating characteristics data can also be displayed through a separate dialog box or another window.

The following is a detailed description of a practical application example of the computer-aided ultrahigh-frequency circuit model simulation system of the invention 100. In this application example, it is assumed that the user (i.e., circuit design engineer) wants to design a parallel pair of transmission lines, so that the user wants to utilizes the simulation system of the invention 100 for simulation of the transmission line pair.

Referring to FIG. 1 together with FIG. 2, in operation, the user needs first to activate the simulation system of the invention 100. When activated, a graphic interface 200 as shown in FIG. 2 is displayed on the monitor screen 11 of the computer platform 10. Since the user wants to design a transmission line pair, the user needs to utilize the mouse 12 to select the corresponding icon from the circuit model selection bar 210. This action initiates a user-operated circuit model selection event 301, whereby a schematic graphic representation of the user-selected circuit model (i.e., transmission line pair) is displayed through the circuit model display area 220. The displayed transmission line pair also shows its design parameters W1, W2, H, H1, T, T1, T2, and S. Next, the user needs to utilize the keyboard 13 to input the user-specified values for these design parameters through the design parameters input area 230. This action initiates a user-operated design parameter input event 302. When completed, the user can then click on the [Simulate] button 250, whereby the graphic-interface circuit model defining module 110 is activated to issue an enable message to the design parameter processing module 120. In response, the design parameter processing module 120 is activated to process the user-inputted design parameters based on a set of simulation equations in relation to the user-selected circuit model (i.e., transmission line pair) for obtaining a set of operating characteristics data 303 about the user-selected circuit model. In the case of transmission line pair, the operating characteristics data 303 include characteristic impedance Z₀, backward crosstalk coefficient Kb, and forward crosstalk coefficient Kf. The simulation result output module 130 is then activated to display the values of Z₀, Kb, and Kf through the simulation result display area 240 of the graphic interface 200.

If the user is unsatisfactory with the simulation result, a new set of design parameters can be inputted through the design parameters input area 230 of the graphic interface 200 for the simulation system of the invention 100 to output a new set of operating characteristics data. Otherwise, if the user is satisfactory with the simulation result, the design parameters can then be actually used for the design of a transmission line pair.

In conclusion, the invention provides a computer-aided ultrahigh-frequency circuit model simulation method and system for use with a computer platform for providing a user-operated ultrahigh-frequency circuit model simulation function, which is characterized by the provision of a graphic interface that allows the user to select a desired circuit model and input a set of design parameters about the selected circuit model, and whereupon a set of operating characteristics data can be automatically determined through simulation. This feature allows the circuit design engineer unnecessary to write lengthy circuit model description files for the description of the intended circuit models, thereby making the simulation of high-speed digital circuit models more convenient and efficient. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A computer-aided ultrahigh-frequency circuit model simulation method for use on a computer platform for providing a computer platform for providing a user-operated ultrahigh-frequency circuit model simulation function, which comprises, which comprises:
displaying a graphic interface on the computer platform for providing a user-operated circuit model selection function and a user-operated design parameter input function, wherein the user-operated circuit model selection function provides a group of predefined circuit models for user-selection, and the user-operated design parameter input function is used for input of a set of design parameters in relation to a user-selected circuit model;
processing the user-inputted design parameters based on a set of simulation equations related to the user-selected circuit model for obtaining a set of operating characteristics data about the user-selected circuit model; and
outputting the operating characteristics data on the computer platform.

2. The computer-aided ultrahigh-frequency circuit model simulation method as recited in claim 1, wherein the computer platform is a computer-aided circuit design workstation.

3. The computer-aided ultrahigh-frequency circuit model simulation method as recited in claim 1, wherein the user-defined circuit model is a pair of ultrahigh-frequency transmission lines for high-speed digital circuit board design.

4. The computer-aided ultrahigh-frequency circuit model simulation method as recited in claim 1, which is implemented as a plug-in software program for integration to a HSPICE circuit simulation program.

5. A computer-aided ultrahigh-frequency circuit model simulation system for use with a computer platform for providing a user-operated ultrahigh-frequency circuit model simulation function, which comprises:
a graphic-interface circuit model defining module, which is capable of displaying a graphic interface on the computer platform for providing a user-operated circuit model selection function and a user-operated design parameter input function, wherein the user-operated circuit model selection function provides a group of predefined circuit models for user-selection, and the user-operated design parameter input function is used for input of a set of design parameters in relation to a user-selected circuit model;
a design parameter processing module, which is capable of processing the user-inputted design parameters received by the graphic-interface circuit model defining module based on a set of simulation equations related to the user-selected circuit model for obtaining a set of operating characteristics data about the user-selected circuit model; and
a simulation result output module, which is capable of outputting the operating characteristics data obtained by the design parameter processing module on the computer platform.

6. The computer-aided ultrahigh-frequency circuit model simulation system as recited in claim 5, wherein the computer platform is a computer-aided circuit design workstation.

7. The computer-aided ultrahigh-frequency circuit model simulation system as recited in claim 5, wherein the user-defined circuit model is a pair of ultrahigh-frequency transmission lines for high-speed digital circuit board design.

8. The computer-aided ultrahigh-frequency circuit model simulation system as recited in claim 5, which is implemented as a plug-in software program for integration to a HSPICE circuit simulation program.
